(19) United States
(12) Patent Application Publication
(10) Pub. No.: US 2008/0259748 A1
(43) Pub. Date: Oct. 23, 2008

(54) OPTICAL DISC AND OPTICAL DISC APPARATUS

(75) Inventors: Takeyuki MINAMIMOTO, Kawasaki-City (JP); Masakatsu KINOSHITA, Kawasaki-City (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Samsung Storage Technology Corporation, Kawasaki-City (JP)

(21) Appl. No.: 12/104,054

(22) Filed: Apr. 16, 2008

(30) Foreign Application Priority Data
Apr. 18, 2007 (JP) 2007-109652

(51) Int. Cl. G11B 7/00

(52) U.S. Cl. 369/43

(57) ABSTRACT

An optical disc includes a SPOKE potion for detecting a position in a circumferential direction of the optical disc, which is formed on an inner or outer circumferential side relative to a data recording area and visible image drawing area. A signal portion in which each signal is constituted by a pair of light nonreflecting portion and light reflecting portion is formed in the SPOKE portion. The signal portion includes a first signal portion in which signal widths of the nonreflecting portion and reflecting portion are the same and a second signal portion in which the signal widths of the nonreflecting portion and reflecting portion are changed.

### CROSS-REFERENCE TO RELATED APPLICATIONS

This application is based upon and claims the benefit of priority from the prior Japanese Patent Application No. 2007-109652, filed on Apr. 18, 2007; the entire contents of which are incorporated herein by reference.

### BACKGROUND OF THE INVENTION

1. Field of the Invention

The present invention relates to an optical disc and an optical disc apparatus and, more particularly, to an optical disc having information for position determination in the circumferential direction thereof and an optical disc apparatus that determines a position in the circumferential direction of the optical disc.

2. Description of the Related Art

There has been proposed a technique that uses a laser beam emitted from an optical pickup head of an optical disc apparatus to form an image or character on the label surface of an optical disc (e.g., Jpn. Pat. Appln. Laid-Open Publication No. 2002-203321).

This technique forms, on the label surface of an optical disc, a visible light characteristic changing layer whose visible light characteristics are changed by laser beam irradiation. Then, the optical disc is attached to a turntable of an optical disc apparatus such that the label surface of the optical disc faces an optical pickup head, and the label surface is irradiated with a laser beam emitted from the optical pickup head. In this state, the optical pickup head is moved relative to the label surface of the optical disc therealong. In synchronization with the movement, the visible light characteristic changing layer of the label surface is irradiated with a laser beam modulated in accordance with image data which is emitted from the optical pickup head to change the visible light characteristics of the visible light characteristic changing layer, whereby the corresponding visible image is drawn on the label surface.

Further, a technique, which is disclosed in, e.g., Jpn. Pat. Appln. Laid-Open Publication No. 2003-203348, that forms an image on an optical disc having a recording surface on one side thereof and a theremosensitive surface (label surface) on the other side thereof.

An optical disc apparatus of the above Patent Document includes: an optical pickup head for irradiating an optical disc with a laser beam; an irradiation position adjustment means for adjusting the irradiation position of the laser beam irradiated onto the optical disc from the optical pickup head; and an image formation control means for controlling, when the thermosensitive surface of the optical disc is so set as to face the optical pickup head, the optical pickup head and irradiation position adjustment means such that a visible image corresponding to image information is formed on the thermosensitive surface of the optical disc. With this configuration, the optical pickup is controlled such that the beam-spot diameter of the laser beam with respect to the thermosensitive surface is made larger than the beam-spot diameter of the laser beam with respect to the information recording surface so as to reduce the time required for visible image formation by irradiating a larger area with the laser beam during one rotation of the optical disc.

In general, in image formation on the label surface, a pulse signal (FG pulse) which is generated for each constant rotation angle obtained by dividing one rotation (i.e., 360°) of a spindle motor by a predetermined integer is used for determining the position in the circumferential direction of the optical disc. However, the position determination in the circumferential direction using an electrical signal, such as the FG pulse, obtained by the integral division does not aim to determine the absolute position of an optical disc.

Therefore, the following problems may occur:

(1) In the case where a signal used for the position determination cannot be acquired in a continuous manner due to, e.g., power-off of an optical disc apparatus, image continuity is lost. Therefore, additional image formation, i.e., additional writing cannot be performed.

(2) The FG pulse is an equally-spaced signal, so that when erroneous occurrence of a signal is caused due to noise or vibration, determination of the current position fails. Further, it is difficult to determine even the failure of the current position determination. Thus, the optical disc apparatus of the above Patent Document does not have a restoration means for restoring the determination operation of the current position.

The problem of (2) is particularly serious because an image may deviate from the correct position in the middle of the image formation process.

### BRIEF SUMMARY OF THE INVENTION

It is an object of the present invention to provide a visible image-drawable type optical disc having information for position determination in the circumferential direction thereof and an optical disc apparatus capable of always determining the current position in the circumferential direction of an optical disc and performing additional writing.

In an aspect of the present invention, an optical disc includes a SPOKE potion for detecting the position in the circumferential direction of the optical disc, which is formed on the inner or outer circumferential side relative to a data recording area and visible image drawing area, wherein a signal portion in which each signal is constituted by a pair of light nonreflecting portion and light reflecting portion is formed in the SPOKE portion, and modulation is applied to the width of signals in the signal portion.

### BRIEF DESCRIPTION OF THE DRAWINGS

FIG. 1 is a block diagram showing a configuration of an optical disc apparatus according to an embodiment of the present invention;

FIGS. 2A to 2C are views schematically showing a SPOKE signal formed on an optical disc as viewed in the rotation direction of the optical disc;

FIGS. 3A to 3C are views for explaining a method of adding information to the SPOKE signal;

FIGS. 4A and 4B are views for explaining a method of adding information for Index 0 detection;

FIG. 5 is a view for explaining a method of adding optical disc information; and

FIG. 6 is a view for explaining a method of Index 0 detection in a state where the optical disc information has been added.

### DETAILED DESCRIPTION OF THE PREFERRED EMBODIMENTS

An embodiment of the present invention will be described below with reference to the accompanying drawings. In the accompanying drawings, the same reference numerals refer to the same members throughout, and the overlapped description is omitted.

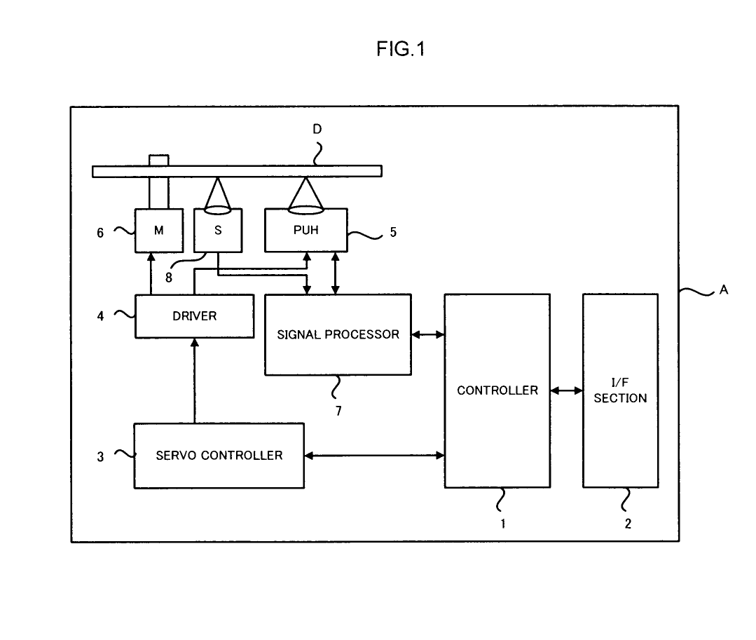

FIG. 1 is a block diagram of an optical disc apparatus according to an embodiment of the present invention. As shown in FIG. 1, an optical disc apparatus 100 has an optical disc D (e.g., a Light Scribe disc) which is capable of recording and reproducing data and on the label surface of which an image can be drawn and is connected to an external host computer via an interface (I/F) section 2. The optical disc apparatus 100 includes a controller 1, a servo controller 3, a driver 4, an optical pickup head 5, a spindle motor 6, a signal processor 7, and a SPOKE sensor 8.

The optical disc D has a recording layer (recording surface) sandwiched by polycarbonate layers. On one surface of the polycarbonate layer, a label surface on which a visible image is drawn is formed. The label surface includes a print area on which a coating material which is chemically changed by a laser beam, an Outer Ring area disposed on the inner circumferential side relative to the print area, and a SPOKE signal area disposed on the inner circumferential side relative to the Outer Ring area.

Onto the Outer Ring area, for example, Index mark, Media ID, or the like is recorded. The Index Mark is used for determining an angle of 0 degree of the optical disc D or synchronization. The Media ID is used for determination of the type of the optical disc D. These information recorded onto the optical disc D can be read out by the optical pickup head 5. The SPOKE signal is used for determining the position in the circumferential direction of the optical disc D. One SPOKE signal is constituted by a pair of a reflecting portion and a nonreflecting portion. For example, 400 spoke signals are formed in the circumferential direction of the optical disc D.

The controller 1 controls the entire operation of the optical disc apparatus 100 and is constituted by a CPU (Central Processing Unit), a ROM (Read Only memory), a RAM (Random Access Memory), and the like. The controller 1 controls respective components of the optical disc apparatus 100 according to a program stored in the ROM to thereby centrally control recording processing of data onto the recording surface of the optical disc D and drawing processing of an image onto the label surface of the optical disc D.

The interface (I/F) section 2 allows the optical disc apparatus 100 to communicate with an external host computer (not shown).

The servo controller 3 receives a focus error signal and a tracking error signal generated in the signal processor 7 and moves an objective lens in the optical pickup head 5 via the driver 4 to thereby perform focus control and tracking control.

The servo controller 3 further receives an instruction signal from the controller 1, an FG pulse signal having a frequency corresponding to the number of rotations of the spindle motor 6, and an RF signal from an RF amplifier. Based on the received signals, the servo controller 3 performs rotation control of the spindle motor 6 and focus control and tracking control of the optical pickup head 5.

The driving mode of the spindle motor 6, when information is recorded on the recording surface of the optical disc D or a visible image is drawn onto the label surface thereof, may be a CAV (Constant Angular Velocity) mode of driving the optical disc D at a constant angular velocity, or a CLV (Constant Linear Velocity) mode of driving the optical disc D at a constant recording linear velocity. The optical disc apparatus 100 shown according to the present embodiment is operated under the CAV mode, in which the servo controller 3 rotates the spindle motor 6 at the constant angular velocity instructed by the controller 1.

The driver 4 drives a focusing actuator or tracking actuator of the objective lens of the optical pickup head 5 according to the focus error signal and tracking error signal from the servo controller 3. This allows the focus control and tracking control between the optical disc D and optical pickup head 5 to be performed.

The optical pickup head 5 is a unit for irradiating the optical disc D, rotated by the spindle motor 6, with a laser beam. Although not shown, the optical pickup head 5 has a laser diode emitting a laser beam, a diffraction grating, an objective lens condensing a laser beam onto the surface of the optical disc D, and a light detecting element for detecting the reflected light. In the optical pickup head 5, a laser beam having an intensity corresponding to the level of a drive current supplied from a laser driver (not shown) is emitted toward the optical disc D.

The spindle motor 6 is a motor rotating and driving the optical disc D onto which the data is recorded, and the rotation speed thereof is controlled by the servo controller 3. In the optical disc apparatus 100 of the present embodiment, which operates under the CAV mode, the spindle motor 6 rotates at the constant angular velocity instructed from the controller 1.

The signal processor 7 outputs a signal modulated in accordance with recorded data to the optical pickup head 5. Further, the signal processor 7 generates signals such as a focus error signal, tracking error signal, and RF signal from a signal supplied from the light detecting element of the optical pickup head 5 using a not shown signal generating circuit. The RF signal is then EFM demodulated to generate reproduction data. The generated reproduction data is then supplied to the controller 1.

The SPOKE sensor 8 reads out an equally-spaced position determining signal (hereinafter, referred to as “SPOKE signal”) formed in the inner circumferential position of the visible image-drawable type optical disc D. The signal read out by the SPOKE sensor 8 is processed in the signal processor 7 as position information in the circumferential direction of the visible image-drawable type optical disc D.

When a visible image is drawn onto the label surface of the optical disc D, the optical disc D is so set in the optical disc apparatus 100 such that the label surface of the optical disc D faces the optical pickup head 5. Then, based on information read out by the SPOKE sensor 8, the circumferential position of the optical disc D is determined. The optical pickup head 5 then irradiates an area on the optical disc D that is determined by tracking control based on the circumferential direction position and address of visible image data with a laser beam under the control of the signal processor 7. That is, the laser beam output from the optical pickup head 5 is irradiated onto the label surface of the optical disc D. The laser beam etches the label surface by a laser beam to cause an occurrence of a pigment change at the irradiated portion, whereby a visible image is formed at the portion.

Next, processing of determining the position in the circumferential direction using the position determining signal of the optical disc D will be described.

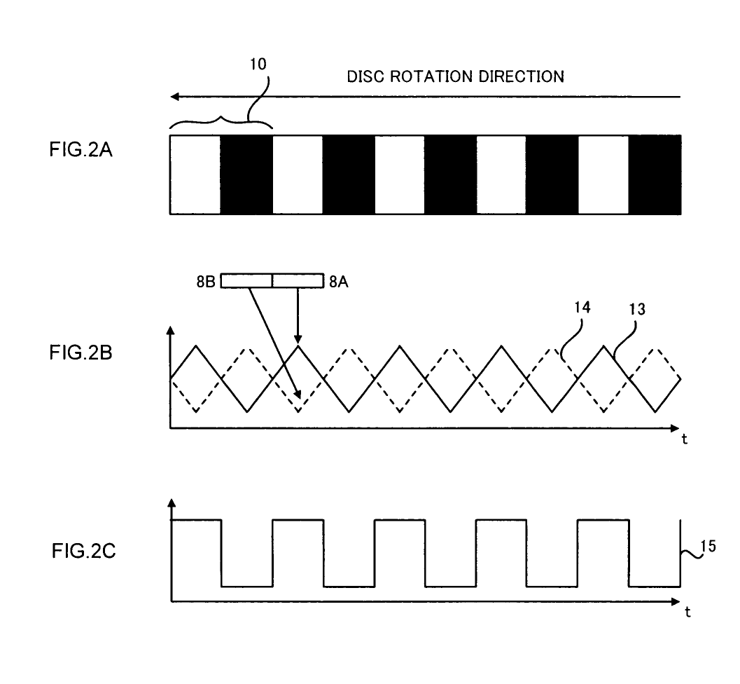

FIGS. 2A to 2C are views concerning the position determination of the optical disc D and optical disc apparatus 100. FIG. 2A schematically shows SPOKE signals formed on the inner circumferential portion of the optical disc D as viewed in the rotation direction, i.e., circumferential direction of the optical disc. In FIG. 2A, a SPOKE 10 is constituted by a pair of a “black area” representing a nonreflecting portion and a “white area” representing a reflecting portion.

The SPOKE signal area is disposed on the inner circumferential side relative to the Outer Ring area, so that the SPOKE signals do not interfere with the optical pickup head 5 reading out the Index mark or Media ID recorded on the Outer Ring area. For example, 400 SPOKE signals are formed in the circumferential direction of the optical disc D so as to generate the signal for determining the position in the circumferential direction. The SPOKE signal area may be formed on the outer circumferential portion on the optical disc D.

In the present embodiment, a photodetector so disposed in the optical disc apparatus as to face the SPOKE 10 is used as the SPOKE sensor 8. FIG. 2B is a view showing a change in the signal of the SPOKE 10 occurring in association with rotation of the optical disc D, which is detected by photodetectors 8A and 8B. In FIG. 2B, a waveform 13 represents an output signal of the photodetector 8A, and a waveform 14 represents an output signal of the photodetector 8B. FIG. 2C is a view showing a SPOKE detection signal 15 obtained by applying signal processing to the detection signals of the photodetectors 8A and 8B using a difference amplifier (not shown).

As shown in FIG. 2C, the SPOKE signal has equally-spaced pulse train and therefore the rising and falling edges appear at equal intervals.

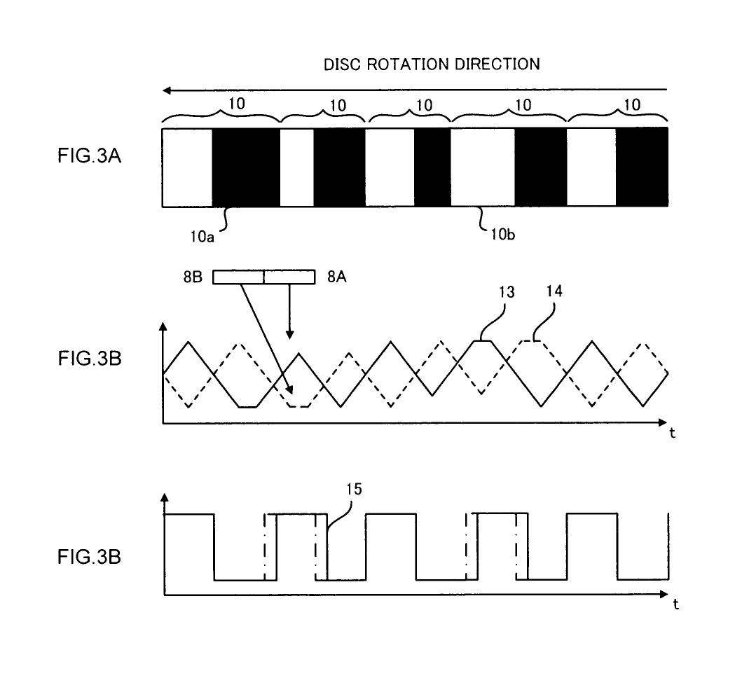

Next, a method of adding information to the SPOKE signal will be described using FIGS. 3A to 3C. In this example, the width of, e.g., only one “black area (nonreflecting part)” (the leftmost black area 10a in FIG. 3A) included in the SPOKEs 10 on the optical disc D is made larger than any other black areas. As a result, the detection signals of the photodetectors 8A and 8B change as shown in FIG. 3B, and the SPOKE detection signal 15 that has been passed through the differential amplifier changes as shown in FIG. 3C.

Further, the width of, e.g., only one “white area (reflecting part)” (the fourth white area 10b from the left in FIG. 3A) included in the SPOKEs 10 on the optical disc D is made larger than any other white areas. As a result, the detection signals of the photodetectors 8A and 8B change as shown in FIG. 3B, and the SPOKE detection signal 15 that has been passed through the differential amplifier changes as shown in FIG. 3C, whereby a waveform whose phase is shifted in the opposite direction is obtained.

Such phase shifts are combined to form a fixed synchronization pattern, whereby the origin (hereinafter, referred to as “Index 0”) in the circumferential direction of the optical disc D can be added to the SPOKE signal. Further, the detection of such a synchronization pattern allows the optical disc apparatus to easily detect the Index 0. Furthermore, it is possible to encode not only the Index 0 but also parameter information concerning the optical disc by using the phase shift.

The above information addition method will be described more concretely.

As a basic concept of the information addition, one out of every two SPOKE signals is subjected to modulation. This allows synchronization to be achieved in units of two SPOKEs, thereby coping with a signal jitter due to rotational unevenness of the optical disc D.

A method of adding information for Index 0 detection will first be described.

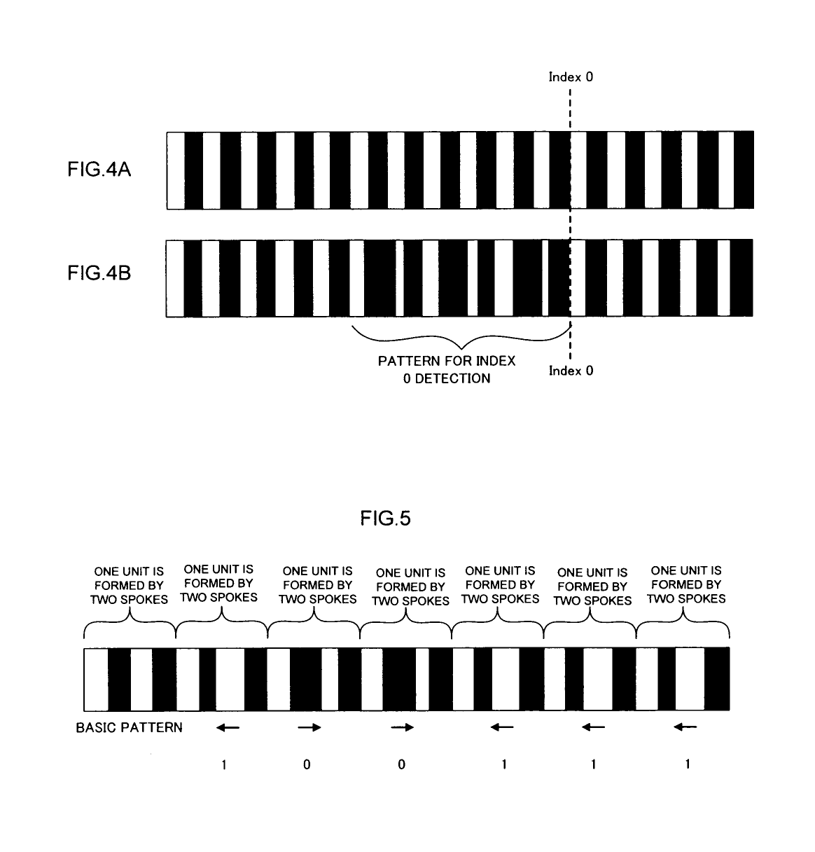

FIGS. 4A and 4B are views for explaining a method of adding information for Index 0 detection. FIG. 4A shows, for comparison, an equally-spaced SPOKE signal pattern, and FIG. 4B shows a SPOKE signal pattern to which information has been added.

In this example, six SPOKE signals (black and white patterns) positioned before the Index 0 representing the origin in the circumferential direction of the optical disc D are configured to be a particular pattern in which the widths of the nonreflecting parts and reflecting parts are not constant. By detecting the rising and falling edges of the SPOKE signal output from the photodetectors 8A and 8B that have detected the particular pattern, the position of the Index 0 can be determined.

A method of adding unique information of the optical disc D to the SPOKE signal will next be described.

Examples of the unique parameter information of an optical disc include, e.g., name of manufacturer, type of optical disc, and registration ID assigned by type. FIG. 5 is a view for explaining a method of adding such information concerning the optical disc. As shown in FIG. 5, a case where the interval between the SPOKE signals each constituted by a black and white pattern is shifted to the left is defined as “1”, and a case where the interval between the SPOKE signals is shifted to the right is defined as “0”, whereby bit information of “1” or “0” can be added to the SPOKE signal. In the example of FIG. 5, bit information of “100111” has been added.

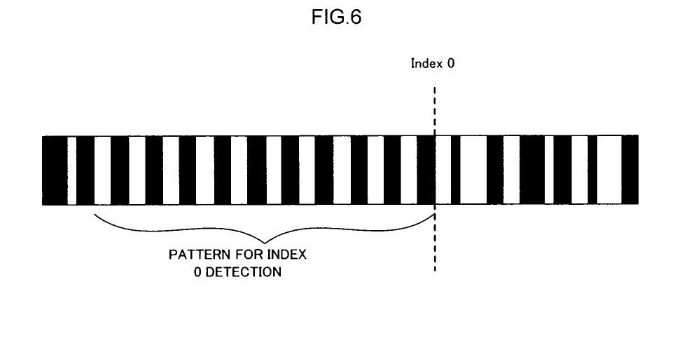

A method of detecting the Index 0 in a state where the optical disc information has been added to the SPOKE signal will next be described. As shown in FIG. 6, equally-spaced SPOKE signals (black and white patterns) having a predetermined length are positioned before the Index 0 as a pattern for Index 0 detection. The abovementioned optical disc information represented by bit information of “1” or “0” is added continuously from the pattern for Index 0 detection.

As described above, in the present embodiment, predetermined modulation is applied to the SPOKE signal pattern disposed on the inner or outer circumferential side of the optical disc, whereby the position in the circumferential direction of the optical disc can always be detected. Therefore, it is possible to perform additional writing of a visible image onto the label surface of the optical disc D without an occurrence of displacement in the rotation direction of the optical disc. Further, parameter information can be recorded onto the SPOKE signal, which allows information concerning the optical disc to be read out only using the SPOKE sensor 8 without requiring signal readout operation using the optical pickup head.

The present invention is not limited to the above embodiment but various modifications can be made within the scope of the present invention. Further, various inventions can be formed by appropriately combining a plurality of required constituent elements disclosed in the embodiment. For example, some required constituent elements may be omitted from all required constituent elements disclosed in the embodiment. Furthermore, required constituent elements across different embodiments may be appropriately combined.

What is claimed is:

1. An optical disc comprising:
a SPOKE potion for detecting a position in a circumferential direction of the optical disc, which is formed on an inner or outer circumferential side relative to a data recording area and visible image drawing area,
wherein a signal portion in which each signal is constituted by a pair of light nonreflecting portion and light reflecting portion is formed in the SPOKE portion, and modulation is applied to a width of signals in the signal portion.

2. An optical disc comprising:
a SPOKE potion for detecting a position in a circumferential direction of the optical disc, which is formed on an inner or outer circumferential side relative to a data recording area and visible image drawing area,
wherein a signal portion in which each signal is constituted by a pair of light nonreflecting portion and light reflecting portion is formed in the SPOKE portion, and
signal widths of the nonreflecting portion and reflecting portion are changed.

3. An optical disc comprising:
a SPOKE potion for detecting a position in a circumferential direction of the optical disc, which is formed on an inner or outer circumferential side relative to a data recording area and visible image drawing area,
wherein a signal portion in which each signal is constituted by a pair of light nonreflecting portion and light reflecting portion is formed in the SPOKE portion, and
the signal portion includes a first signal portion in which signal widths of the nonreflecting portion and reflecting portion are the same and a second signal portion in which the signal widths of the nonreflecting portion and reflecting portion are changed.

4. The optical disc according to claim 2 or 3, wherein
the change in the signal widths is a result of combining modulation applied to the signal width to the nonreflecting portion and modulation applied to the signal width of the reflecting portion.

5. The optical disc according to claim 2 or 3, wherein
the change in the signal widths is a result of combining modulation applied to the signal width to the nonreflecting portion and modulation applied to the signal width of the reflecting portion, the modulation being applied by two pairs of the nonreflecting and reflecting portions.

6. The optical disc according to claim 3, wherein
the origin in the circumferential direction of the optical disc is detected by the first signal portion.

7. The optical disc according to claim 3, wherein
the second signal portion corresponds to unique information of the optical disc.

8. The optical disc according to claim 7, wherein
the second signal portion corresponds to bit information including logic “1” representing modulation applied to the signal width of the reflecting portion and logic “0” representing modulation applied to the signal width of the nonreflecting portion.

9. An optical disc apparatus in which an optical disc according to any one of claims 1 to 3 is set and which demodulates position information in the circumferential direction of the optical disc.

10. The optical disc apparatus according to claim 9, wherein
the position information is sensed by a photodetector.

11. An optical disc apparatus in which an optical disc according to any one of claims 1 to 3 is set and which has a signal processor for decoding parameter information concerning the optical disc.

12. The optical disc apparatus according to claim 11, wherein
the parameter information is sensed by a photodetector.
